(19) United States
(12) Patent Application Publication
(10) Pub. No.: US 2026/0034446 A1
(43) Pub. Date: Feb. 5, 2026

(54) VIRTUAL CHARACTER SWITCHING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Qingbo YU, Shenzhen (CN); Ya ZHANG, Shenzhen (CN); Yinchao CHEN, Shenzhen (CN)

(73) Assignee: TENCENT TECHNOLOGY (SHENZHEN) COMPANY LIMITED, Shenzhen (CN)

(21) Appl. No.: 19/353,724

(22) Filed: Oct. 9, 2025

Related U.S. Application Data
(63) Continuation of application No. PCT/CN2024/116910, filed on Sep. 4, 2024.

(30) Foreign Application Priority Data
Nov. 17, 2023 (CN) 202311548128.7

(51) Int. Cl. A63F 13/5252; A63F 13/533; A63F 13/537

(52) U.S. Cl. CPC A63F 13/5252; A63F 13/533; A63F 13/537

(57) ABSTRACT

A virtual character switching method, apparatus, and computer-readable storage medium for seamless character transitions in virtual environments. The method displays a first viewing angle picture corresponding to a first virtual character serving as the main control character. Upon receiving a character switching operation to change from the first to a second virtual character, a character switching process is presented featuring an intermediate viewing angle presentation process that transitions from the first viewing angle to a second viewing angle. After completing the switching process, a second viewing angle picture corresponding to the second virtual character's perspective is displayed, enabling smooth and visually coherent character transitions in virtual scenes.

### CROSS-REFERENCE TO RELATED APPLICATIONS

This application is a continuation application of International Application No. PCT/CN2024/116910 filed on Sep. 4, 2024 which claims priority to Chinese Patent Application No. 202311548128.7, filed with the China National Intellectual Property Administration on Nov. 17, 2023, the disclosures of each being incorporated by reference herein in their entireties.

### FIELD

The disclosure relates to the field of virtual scene technologies, a virtual character switching method and apparatus, a device, a storage medium, and a program product.

### BACKGROUND

In some virtual games, when a virtual game includes a plurality of virtual characters that can provide viewing angle pictures, a user may select a target virtual character through a switching operation, so as to display a viewing angle picture corresponding to the target virtual character.

In the related art, character switching may be usually implemented by a simple key operation. A user presses a specified key, a game character is immediately switched, and a viewing angle picture may be switched to that of a target character at the same time. The character switching may be implemented by detecting a key input of the user. When a game program detects that the user presses the specified key, the game program immediately may invoke a character switching function, to switch the current game character to another character.

However, the process is usually instantly completed, and a viewing angle switching process accompanying character switching is relatively stiff and lacks continuity.

### SUMMARY

Provided are a virtual character switching method and apparatus, a device, a storage medium, and a program product, which can implement smooth character transitions through intermediate viewing angle presentation processes in virtual environments.

According to some embodiments, a virtual character switching method, performed by a computer device, includes: displaying a first viewing angle picture of a virtual scene, wherein the first viewing angle picture corresponds to a first viewing angle of a first virtual character that is a main control virtual character; based on receiving a character switching operation for switching the main control virtual character from the first virtual character to a second virtual character, presenting a character switching process that includes an intermediate viewing angle presentation process corresponding to an intermediate viewing angle for transition from the first viewing angle to a second viewing angle; and displaying a second viewing angle picture of the virtual scene corresponding to the second viewing angle of the second virtual character after completion of the character switching process.

According to some embodiments, a virtual character switching apparatus, includes: at least one memory configured to store program code; and at least one processor configured to read the program code and operate as instructed by the program code, the program code including: first display code configured to cause at least one of the at least one processor to display a first viewing angle picture of a virtual scene, wherein the first viewing angle picture corresponds to a first viewing angle of a first virtual character that is a main control virtual character; switching code configured to cause at least one of the at least one processor to present, based on receiving a character switching operation for switching the main control virtual character from the first virtual character to a second virtual character, a character switching process that includes an intermediate viewing angle presentation process corresponding to an intermediate viewing angle for transition from the first viewing angle to a second viewing angle; and second display code configured to cause at least one of the at least one processor to display a second viewing angle picture of the virtual scene corresponding to the second viewing angle of the second virtual character after completion of the character switching process.

According to some embodiments, a non-transitory computer-readable storage medium, storing computer code which, when executed by at least one processor, causes the at least one processor to at least: display a first viewing angle picture of a virtual scene, wherein the first viewing angle picture corresponds to a first viewing angle of a first virtual character that is a main control virtual character; present, based on receiving a character switching operation for switching the main control virtual character from the first virtual character to a second virtual character, a character switching process that includes an intermediate viewing angle presentation process corresponding to an intermediate viewing angle for transition from the first viewing angle to a second viewing angle; and display a second viewing angle picture of the virtual scene corresponding to the second viewing angle of the second virtual character after completion of the character switching process.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment according to some embodiments.

FIG. 2 is a flowchart of a virtual character switching method according to some embodiments.

FIG. 3 is a schematic diagram of a character switching animation according to some embodiments.

FIG. 4 is a flowchart of a method for displaying a character switching animation according to some embodiments.

FIG. 5 is a flowchart of a method for displaying a character switching control according to some embodiments.

FIG. 6 is a flowchart of a method for displaying a character switching animation according to some embodiments.

FIG. 7 is a flowchart of a method for determining a second virtual character according to some embodiments.

FIG. 8 is a schematic diagram of a method for determining a second virtual character according to some embodiments.

FIG. 9 is a schematic diagram of virtual character switching according to some embodiments.

FIG. 10 is a flowchart of a method for determining a user-switchable character according to some embodiments.

FIG. 11 is a flowchart of a character screening module according to some embodiments.

FIG. 12 is a flowchart of character switching according to some embodiments.

FIG. 13 is a structural block diagram of a virtual character switching apparatus according to some embodiments.

FIG. 14 is a structural block diagram of modules of a virtual character switching apparatus according to some embodiments.

FIG. 15 is a structural block diagram of a terminal according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In some virtual games, when a virtual game includes a plurality of virtual characters that can provide viewing angle pictures, a user may select a target virtual character through a switching operation, so as to display a viewing angle picture corresponding to the target virtual character. In the related art, character switching is usually implemented by a simple key operation. A user presses a specified key, a game character is immediately switched, and a viewing angle picture is switched to that of a target character at the same time. The character switching is implemented by detecting a key input of the user. When a game program detects that the user presses the specified key, the game program immediately invokes a character switching function, to switch the current game character to another character. However, the process is usually instantly completed, and a viewing angle switching process accompanying character switching is relatively stiff and lacks continuity. Moreover, the process has low fault tolerance to an accidental switching operation of a player and low efficiency of human-computer interaction.

According to the virtual character switching method provided in some embodiments, in a process of switching a main control virtual character of a client, the client is triggered, by using a character switching operation, to present a character switching process to a user, and a first viewing angle picture before viewing angle switching and a second viewing angle picture after the viewing angle switching are connected through the character switching process. The character switching process includes an intermediate viewing angle presentation process, to present an intermediate viewing angle for transition from a first viewing angle of the current main control virtual character to a second viewing angle of a virtual character after the viewing angle switching, and the intermediate viewing angle is a transition viewing angle between the first viewing angle and the second viewing angle. For example, a transition process of switching from the first viewing angle picture to the second viewing angle picture is added by using an intermediate viewing angle picture. Therefore, when a display of a device displays a viewing angle switching process, the display no longer needs to directly switch from the first viewing angle picture to the second viewing angle picture within a short time, and a pixel unit of the display no longer needs to respond to rapid color changes between different viewing angle pictures within a short time, so that hardware pressure of the display and a device video card on picture response is reduced. In addition, the intermediate viewing angle picture enables a more fluent viewing angle switching process that accompanies character switching, so that visual continuity of the viewing angle switching process may be ensured.

In some embodiments, a terminal synchronously displays a character switching animation according to duration of a character switching operation. For example, the character switching animation responds to a character switching operation that is continuously received. A player can stop viewing angle switching at any time in a switching process to return to the first viewing angle picture, thereby improving fault tolerance to an accidental character switching operation, and improving efficiency of human-computer interaction.

First, terms involved in some embodiments are briefly introduced.

Virtual scene: The virtual scene is displayed (or provided) when an application program is run on a terminal. The virtual scene may be a simulated world of a real world, or may be a semi-simulated semi-fictional three-dimensional world, or may be an entirely fictional three-dimensional world. The virtual scene may be any one of a two-dimensional virtual scene, a 2.5-dimensional virtual scene, and a three-dimensional virtual scene. In some embodiments, the virtual scene may be further configured for a virtual battle between at least two virtual characters, and virtual resources available to the at least two virtual characters exist in the virtual scene.

Virtual character: The virtual character is a movable object or an immovable object in a virtual scene. The movable object may be at least one of a virtual person, a virtual animal, and a cartoon character. The immovable object may be at least one of a virtual building, a virtual plant, and a virtual terrain. In some embodiments, when the virtual scene is a three-dimensional virtual scene, the virtual character may be a three-dimensional virtual model, and each virtual character has a shape and a volume in the three-dimensional virtual scene, and occupies a part of space in the three-dimensional virtual scene. Activities of the virtual character include, but are not limited to: at least one of adjusting body postures, crawling, walking, running, riding, flying, jumping, driving, picking, shooting, attacking, and throwing. In some embodiments, the virtual character is a three-dimensional character built based on a three-dimensional human skeleton technology. The virtual character may show different external images through different skins. In some implementations, the virtual character may alternatively be implemented through a 2.5-dimensional model or 2-dimensional model. This is not limited in some embodiments. Exemplarily, the virtual character may be divided into a user-controlled virtual character and a server-controlled virtual character according to different manners of controlling the virtual character. The user-controlled virtual character is an object that is movable in the virtual scene and that is controlled by a client. The server-controlled virtual character is a virtual character controlled by an automatic control algorithm or an artificial intelligence program on a client or a server. The server-controlled virtual character includes a movable object and an immovable object in the virtual scene. Exemplarily, the immovable object may respond to or affect an activity of the movable object. For example, the movable object may destroy the immovable object, or the movable object enters a stealth state when the movable object enters the immovable object. Exemplarily, the virtual character in this application is a client-controlled virtual character.

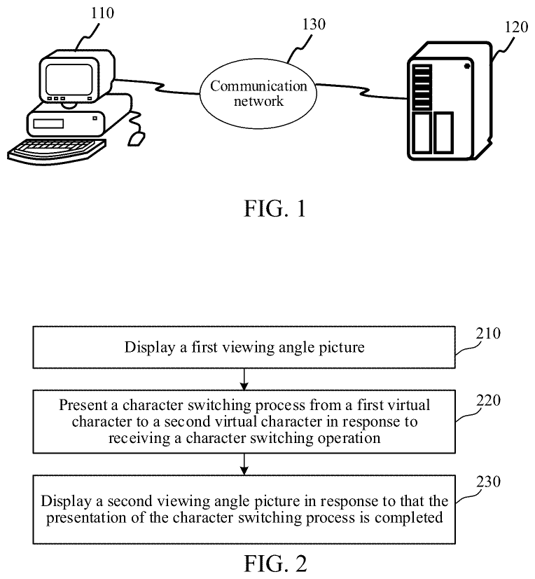

FIG. 1 is a schematic diagram of an implementation environment according to some embodiments. The implementation environment includes: a terminal 110.

In some embodiments, a target application program is installed and run in the terminal 110. The target application program is a target application program that can perform virtual character switching. The target application program may be any one of a virtual reality application, a three-dimensional map program, a strategy game, a third-person shooting (TPS) game, a first-person shooting (FPS) game, a multiplayer online battle arena (MOBA) game, and a massively multiplayer online role-playing game (MMORPG), a multiplayer gunfight survival game, and a multiplayer survival arena game. This is not limited in some embodiments.

The virtual scene is a scene displayed (or provided) when a client of the target application program (such as a game application) runs on a terminal device. The virtual scene refers to an environment created for a virtual character to perform activities (such as game competition), such as a virtual house, a virtual island, or a virtual map. In some embodiments, the virtual scene is an environment displayed (or provided) when an application runs on the terminal device. The virtual scene may be a simulated world of a real world, or may be a semi-simulated semi-fictional three-dimensional world, or may be an entirely fictional three-dimensional world. The virtual scene may be any one of a two-dimensional virtual scene, a 2.5-dimensional virtual scene, and a three-dimensional virtual scene. In some embodiments, the virtual scene may be further configured for a virtual battle between at least two virtual characters, and virtual resources available to the at least two virtual characters exist in the virtual scene.

The virtual character refers to a virtual character, a virtual vehicle, a virtual item, or the like controlled by a user account in the target application program. This is not limited in this application. For example, the target application program is a game application. The virtual character refers to a virtual character controlled by a user account in the game application. The virtual character may be in a human form, an animal form, a cartoon form, or another form. This is not limited in some embodiments. The virtual character may be displayed in a three-dimensional form or a two-dimensional form. This is not limited in some embodiments. Exemplarily, the virtual character may be divided into a user-controlled virtual character and a server-controlled virtual character according to different manners of controlling the virtual character. The user-controlled virtual character is an object that is movable in the virtual scene and that is controlled by a client. The server-controlled virtual character is a virtual character controlled by an automatic control algorithm or an artificial intelligence program on a client or a server. The server-controlled virtual character includes a movable object and an immovable object in the virtual scene. Exemplarily, a first virtual character and a second virtual character in this application are both client-controlled virtual characters. In some embodiments, when the first virtual character is a virtual character controlled by the client based on a user operation, the second virtual character is a virtual character automatically controlled by the client based on artificial intelligence; or, when the second virtual character is a virtual character controlled by the client based on a user operation, the first virtual character is a virtual character automatically controlled by the client based on artificial intelligence.

In some embodiments, the terminal 110 displays a first viewing angle picture corresponding to a virtual scene, the first viewing angle picture corresponding to a first viewing angle of a first virtual character, and the first virtual character being a main control virtual character; displays a character switching animation in response to receiving a character switching operation, the character switching operation being configured for switching the main control virtual character from the first virtual character to a second virtual character, a second viewing angle of the second virtual character corresponding to a second viewing angle picture, the character switching animation including an intermediate viewing angle picture, the intermediate viewing angle picture being a picture corresponding to an intermediate viewing angle for transition from the first viewing angle to the second viewing angle, and the character switching animation including a conversion process of switching from the first viewing angle picture to the second viewing angle picture; and displays the second viewing angle picture corresponding to the virtual scene in response to that the display of the character switching animation is completed.

In some embodiments, the implementation environment further includes a server 120 and a communication network 130.

The terminal 110 and the server 120 perform data transmission by using the communication network 130. The terminal 110 is configured to run a target application program, and the server 120 is configured to provide a background service of the target application program for the terminal 110.

In some embodiments, the terminal 110 displays a first viewing angle picture, the first viewing angle picture being a picture in which a virtual scene is observed from a first viewing angle of a first virtual character, and the first virtual character being a main control virtual character. The terminal 110 sends a character switching request to the server 120 in response to receiving a character switching operation, the server 120 sends a request feedback to the terminal 110 based on the character switching request, and the terminal 110 displays a character switching animation based on the request feedback, the character switching operation being configured for switching the main control virtual character from the first virtual character to a second virtual character, the character switching animation including an intermediate viewing angle picture, the intermediate viewing angle picture being a picture corresponding to an intermediate viewing angle for transition from the first viewing angle to a second viewing angle, and the character switching animation being configured for presenting the conversion process of switching from the first viewing angle to the second viewing angle of the second virtual character. The second viewing angle picture is displayed in response to that the display of the character switching animation is completed.

In some embodiments, the target application program may be a cloud game application program, the server 120 is configured to run the target application program, and the terminal 110 is configured to display a program picture corresponding to the target application program.

In some embodiments, the server 120 renders the first viewing angle picture corresponding to the virtual scene based on the terminal 110 logging in to the target application program, in response to the main control virtual character of the terminal 110 being the first virtual character, to obtain the first rendering result, and sends the first rendering result to the terminal 110. The terminal 110 displays the first viewing angle picture based on the received first rendering result. The terminal 110 sends operation data corresponding to the character switching operation to the server 120, in response to receiving the character switching operation. The server 120 renders a character switching animation based on the operation data, to obtain the second rendering result, and sends the second rendering result to the terminal 110. The terminal 110 displays the character switching animation based on the second rendering result. The server 120 renders the second viewing angle picture based on the operation data, to obtain the third rendering result, and sends the third rendering result to the terminal 110. The terminal 110 displays the second viewing angle picture based on the third rendering result, in response to that the display of the character switching animation is completed.

The terminal may be exemplary. The terminal may be a terminal device in a plurality of forms such as a desktop computer, a portable laptop computer, a mobile phone, a tablet computer, an e-book reader, a moving picture experts group audio layer III (MP3) player, a moving picture experts group audio layer IV (MP4) player, a smart television, and a smart vehicle. This is not limited in some embodiments.

The server may be an independent physical server, or may be a server cluster or a distributed system formed by a plurality of physical servers, or may be a cloud server that provides cloud computing services such as a cloud service, cloud security, a cloud database, cloud computing, a cloud function, cloud storage, a network service, cloud communication, a middleware service, a domain name service, a security service, a content delivery network (CDN), big data, and an artificial intelligence platform.

In some embodiments, the server may alternatively be implemented as a node in a blockchain system.

Information (including but not limited to user equipment information, user personal information, and the like), data (including but not limited to data for analysis, data for storage, data for display, and the like), and signals involved in this application are all authorized by users or fully authorized by all parties, and collection, use, and processing of relevant data may comply with relevant laws, regulations, and standards of relevant regions. For example, operation data and account information involved in this application are all obtained under full authorization.

Further, in this application, before and during acquisition of relevant data (for example, account information, operation data, and the like involved in this application) of a user, a prompt interface or a pop-up window may be displayed, or speech prompt information may be outputted. The prompt interface, the pop-up window, or the speech prompt information is configured for prompting the user that the relevant data of the user is currently being acquired. In this way, in this application, only after a confirmation operation performed by the user for the prompt interface or the pop-up window is obtained, relevant operations of obtaining the relevant data of the user start to be performed. Otherwise (for example, when the confirmation operation performed by the user for the prompt interface or the pop-up window is not obtained), the relevant operations of obtaining the relevant data of the user are ended, for example, the relevant data of the user is not obtained. In other words, all user data acquired in this application is acquired with user consent and authorization, and acquisition, use, and processing of relevant user data may comply with relevant laws, regulations, and standards of relevant regions.

Exemplarily, FIG. 2 is a flowchart of a virtual character switching method according to some embodiments. The method may be performed by a client in a terminal, or by a server, or by a client in a terminal and a server in cooperation. In some embodiments, an example in which the method is performed by a terminal is configured for description. As shown in FIG. 2, the method includes the following operations:

Operation 210: Display a first viewing angle picture.

The first viewing angle picture corresponds to a first viewing angle of a first virtual character. For example, the first viewing angle picture is a picture in which a virtual scene is observed from the first viewing angle of the first virtual character, and the first virtual character is a main control virtual character.

The virtual scene is a scene provided when the target application program in the terminal is rendered and run. The virtual scene includes a plurality of virtual characters, the plurality of virtual characters include the first virtual character, the first virtual character is the main control virtual character, and the main control virtual character refers to a virtual character controlled by a client to which the first account logs in at the current moment.

In some embodiments, a character state of a virtual character in the virtual scene includes a controllable state and an uncontrollable state. The controllable state is configured for indicating that the virtual character belongs to a candidate virtual character, and the candidate virtual character may be determined as a main control virtual character, for example, the candidate virtual character is a virtual character that can be controlled by the terminal. The uncontrollable state is configured for indicating that the virtual character does not belong to a candidate virtual character, for example, a virtual character controlled by the server or another terminal.

In some embodiments, when the virtual character in the uncontrollable state is a virtual character controlled by the server, the virtual character may alternatively be a character controlled by using an artificial intelligence (AI) technology.

The controllable state and the uncontrollable state of the virtual character in the virtual scene may be pre-configured by the target application program, or may be configured by the user.

In some embodiments, the controllable state and the uncontrollable state of the virtual character in the virtual scene are determined based on a camp to which the virtual character belongs. For example, a virtual character in a camp in which the first account is located is in the controllable state, and a virtual character in another camp is in the uncontrollable state.

The main control virtual character may be any one of a plurality of candidate virtual characters, and the main control virtual character may be preset by the target application program based on the plurality of candidate virtual characters, or may be selected by the user from the plurality of candidate virtual characters. The main control virtual character is switchable, for example, the main control virtual character may switch from one of the plurality of candidate virtual characters to another candidate virtual character.

A character state of a candidate virtual character that belongs to the controllable state includes a first state and a second state. The first state is configured for indicating that the candidate virtual character is determined as the main control virtual character, and the second state is configured for indicating that the candidate virtual character does not currently belong to the main control virtual character.

In some embodiments, the main control virtual character may be a virtual character actively controlled by the terminal based on a user operation, or may be a virtual character automatically controlled by the terminal based on a preset program such as artificial intelligence.

Exemplarily, the virtual scene includes a plurality of candidate virtual characters. The plurality of candidate virtual characters include the first virtual character and the second virtual character. Assuming that the first virtual character is the main control virtual character, the main control virtual character may be switched to the second virtual character. When the first virtual character is the main control virtual character, the first virtual character belongs to the first state and is actively controlled by a user, and the second virtual character belongs to the second state and is automatically controlled by a preset program or AI. When the main control virtual character is switched to the second virtual character, the first virtual character is adjusted to the second state and is automatically controlled by the preset program or AI, and the second virtual character is adjusted to the first state and is actively controlled by the user.

When the first virtual character or the second virtual character in the virtual scene is in the second state, for example, the virtual character is a character not mainly controlled by the user, the preset program or AI takes over control of the virtual character, so as to ensure fluency of game play, avoid an error in a game process, avoid an error in an application program, and improve stability of a game program.

In some embodiments, the terminal displays, according to a viewing angle of the main control virtual character, a virtual scene picture corresponding to the viewing angle, and displays the first viewing angle picture when the main control virtual character is the first virtual character.

In some embodiments, the first viewing angle corresponding to the first virtual character may be a first-person view (FPV), a second-person view (2 PV), a third-person view (3 PV), or any other viewing angle corresponding to the first virtual character. In some embodiments, the third-person view is used as an example for description.

In some embodiments, when the first viewing angle is a first-person view, the head model of the first virtual character is provided with a virtual camera, and the virtual camera is configured to capture the first viewing angle picture corresponding to the first viewing angle. For example, under the first-person view, the head of the first virtual character is considered as a position of the virtual camera, and an orientation of the head of the first virtual character is an orientation of the virtual camera. Therefore, the viewing angle of the virtual camera is considered as the first viewing angle corresponding to the first virtual character.

In some other embodiments, when the first viewing angle is a third-person view, a virtual spring arm (not visible in the virtual scene picture) is connected to a virtual camera configured to capture the first viewing angle picture. For example, a first end of the virtual spring arm is connected to the virtual camera, and a second end is connected to the first virtual character, so that the first viewing angle picture displayed by using the virtual camera moves with movement of the first virtual character. In some embodiments, an extension size of the virtual spring arm is variable. For example, according to a distance setting corresponding to the first viewing angle, the virtual spring arm controls the position of the virtual camera relative to the first virtual character at an extension size corresponding to the distance setting.

Operation 220: Present a character switching process from the first virtual character to the second virtual character in response to receiving a character switching operation.

The character switching operation is configured for switching the main control virtual character from the first virtual character to the second virtual character, the second virtual character corresponds to a second viewing angle, and the second viewing angle of the second virtual character corresponds to a second viewing angle picture. In some embodiments, the second viewing angle may be a first-person view, a second-person view, a third-person view, or any other viewing angle corresponding to the second virtual character.

In some embodiments, when the second viewing angle is a first-person view, the head model of the second virtual character is provided with a virtual camera, and the virtual camera is configured to capture the second viewing angle picture corresponding to the second viewing angle. For example, under the first-person view, the head of the second virtual character is considered as a position of the virtual camera, and an orientation of the head of the second virtual character is an orientation of the virtual camera. Therefore, the viewing angle of the virtual camera is considered as the second viewing angle corresponding to the second virtual character.

In some other embodiments, when the second viewing angle is a third-person view, a virtual spring arm (not visible in the virtual scene picture) is connected to a virtual camera configured to capture the first viewing angle picture. For example, the first end of the virtual spring arm is connected to the virtual camera, and the second end is connected to the second virtual character, so that the second viewing angle picture displayed by using the virtual camera moves with movement of the second virtual character. In some embodiments, an extension size of the virtual spring arm is variable. For example, according to a distance setting corresponding to the second viewing angle, the virtual spring arm controls the position of the virtual camera relative to the second virtual character at an extension size corresponding to the distance setting.

Exemplarily, the character switching process includes an intermediate viewing angle presentation process. The intermediate viewing angle presentation process is a process corresponding to an intermediate viewing angle for transition from the first viewing angle to the second viewing angle. The intermediate viewing angle is a transition viewing angle in a process of switching from the first viewing angle of the first virtual character to the second viewing angle of the second virtual character.

Exemplarily, the intermediate viewing angle is a viewing angle at which the virtual camera shoots the virtual scene in a transition process in which the virtual camera configured to provide the virtual scene picture transitions from the first camera position corresponding to the first viewing angle to the second camera position corresponding to the second viewing angle.

In some embodiments, when the first viewing angle and the second viewing angle are both first-person views, the intermediate viewing angle includes a transition viewing angle of switching the first viewing angle from a first-person view to a third-person view of the first virtual character, a viewing angle of a virtual camera in a process of moving from the first camera position at which the third-person view of the first virtual character is located to the second camera position at which the third-person view of the second virtual character is located, and a viewing angle of switching from the third-person view of the second virtual character to the second viewing angle (i.e., the first-person view) of the second virtual character.

In some embodiments, when the first viewing angle and the second viewing angle are both third-person views, the intermediate viewing angle includes a viewing angle of a virtual camera in a process of moving from the first camera position at which the third-person view of the first virtual character is located to the second camera position at which the third-person view of the second virtual character is located.

In some embodiments, when the first viewing angle is a first-person view and the second viewing angle is a third-person view, the intermediate viewing angle includes a transition viewing angle of switching the first viewing angle from a first-person view to a third-person view of the first virtual character, and a viewing angle of a virtual camera in a process of moving from the first camera position at which the third-person view of the first virtual character is located to the second camera position at which the third-person view of the second virtual character is located.

In some embodiments, when the first viewing angle is a third-person view and the second viewing angle is a first-person view, the intermediate viewing angle includes a viewing angle of a virtual camera in a process of moving from the first camera position at which the third-person view of the first virtual character is located to the second camera position at which the third-person view of the second virtual character is located, and a viewing angle of switching from the third-person view of the second virtual character to the second viewing angle (i.e., the first-person view) of the second virtual character.

Exemplarily, the character switching process is configured for indicating a process of transition from the first viewing angle of the first virtual character to the second viewing angle of the second virtual character. The transition of the viewing angle includes translation and/or rotation of the viewing angle. In some embodiments, when the first viewing angle and the second viewing angle are viewing angles pointing to the same direction, the transition process includes translation of the viewing angle. When the first viewing angle and the second viewing angle are viewing angles pointing to different directions, the transition process includes translation and rotation of the viewing angle.

In some embodiments, presenting a character switching process from the first virtual character to the second virtual character is implemented as: displaying a character switching animation in response to receiving a character switching operation, the character switching animation including an intermediate viewing angle picture, the intermediate viewing angle picture being a picture corresponding to an intermediate viewing angle for rotation from the first viewing angle to the second viewing angle, and the character switching animation including a conversion process of switching from the first viewing angle picture corresponding to the first viewing angle to the second viewing angle picture corresponding to the second viewing angle, for example, the character switching animation is configured for displaying a conversion process of switching from the first viewing angle to the second viewing angle of the second virtual character.

In some embodiments, the character switching operation may be an operation that may consume a first duration threshold to complete character switching, such as a long press operation, a continuous clicking operation, or a continuous shaking operation. In some embodiments, the long press operation is used as an example for description. When duration of the character switching operation reaches the first duration threshold, and the main control virtual character is switched from the first virtual character to the second virtual character, character switching is considered as being succeeded.

In some embodiments, the character switching animation is synchronously displayed based on the duration of the character switching operation. For example, duration of the character switching animation is synchronous with the duration of the character switching operation. After the client receives an operation trigger signal of the character switching operation, the client starts to play the character switching animation.

In some embodiments, in response to receiving a continuous character switching operation, the character switching animation is continuously displayed synchronously with the character switching operation; switching from the main control virtual character to the second virtual character is displayed in response to that the duration of the character switching operation reaches the first duration threshold; or, in response to that the duration when the character switching operation is terminated is less than the first duration threshold, the display of the character switching animation is stopped, the display of the first viewing angle picture is resumed, and the main control virtual character is controlled to remain as the first virtual character.

The first duration threshold is configured for indicating duration for which the character switching operation may be continued for switching the main control virtual character from the first virtual character to the second virtual character.

Exemplarily, taking an example in which the first duration threshold is five seconds, when a client detects an operation trigger signal of a character switching operation, the client starts to display a character switching animation. For example, at the fourth second after detecting the operation trigger signal, the client detects that the operation trigger signal is interrupted, the client determines that the character switching operation is suspended, and the client resumes displaying the first viewing angle picture. For another example, if the client detects that the operation trigger signal lasts for six seconds, when the operation trigger signal lasts to the fifth second, playing of the character switching animation is ended, and the second viewing angle picture after the main control virtual character is switched to the second virtual character is displayed.

In some embodiments, the intermediate viewing angle picture in the character switching animation may be determined, and operation 220 is implemented as the following three operations:

Operation I: Determine a viewing angle conversion route corresponding to the character switching animation based on the first virtual character and the second virtual character in response to receiving the character switching operation.

The viewing angle conversion route is configured for determining the intermediate viewing angle.

In some embodiments, the viewing angle conversion route is a connection line between a viewing angle point corresponding to the first viewing angle and a viewing angle point corresponding to the second viewing angle. In some embodiments, the connection line may be a straight line, or may be a curve.

Exemplarily, an example in which a viewing angle point is implemented as a center point of a virtual character is used. If the viewing angle conversion route is implemented as a straight line, a line segment between the first center point corresponding to the first virtual character and the second center point corresponding to the second virtual character is determined as the viewing angle conversion route. If the viewing angle conversion route is implemented as a curve, taking a semi-circular arc as an example, a midpoint of the line segment is used as a center of a sphere, half the length of the line segment is used as a radius, and any semi-circular arc from the first center point to the second center point in the sphere is determined as the viewing angle conversion route.

The manner of determining the viewing angle conversion route is merely an exemplary example. This is not limited in this application.

Operation II: Determine a plurality of viewing angle transition points in the viewing angle conversion route according to a first interval threshold.

The viewing angle transition points are configured for indicating an intermediate viewing angle for transition from the first viewing angle to the second viewing angle.

In some embodiments, distances between the plurality of viewing angle transition points may be the same, or may be different.

Operation III: Display the character switching animation based on the plurality of viewing angle transition points.

The character switching animation includes intermediate viewing angle pictures under the intermediate viewing angle corresponding to the plurality of viewing angle transition points.

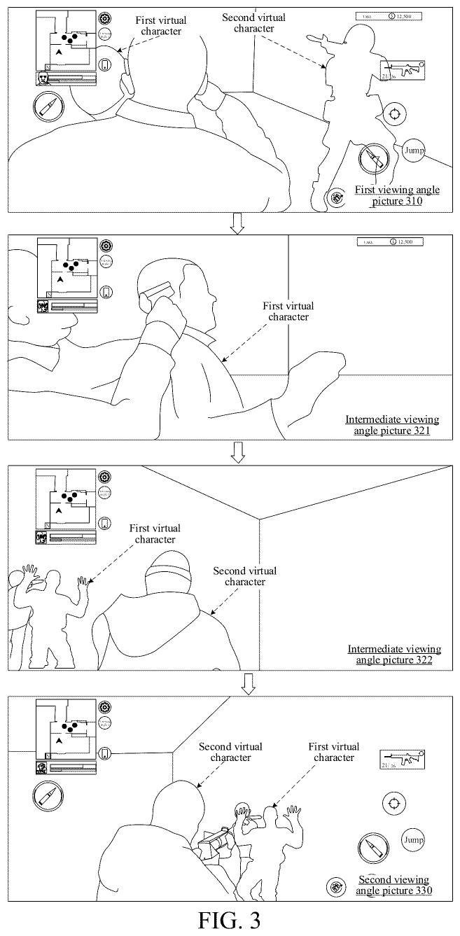

Exemplarily, FIG. 3 is a schematic diagram of a character switching animation according to some embodiments. As shown in FIG. 3, a terminal displays the first viewing angle picture 310, and displays a character switching animation in response to receiving a character switching operation. The character switching animation includes an intermediate viewing angle picture 321 and an intermediate viewing angle picture 322, and displays the second viewing angle picture 330 in response to that the display of the character switching animation is completed.

In some embodiments, the character switching operation is received in a case that at least one candidate character exists within a viewing angle range corresponding to the first viewing angle. The viewing angle range is configured for indicating a photographing range of the virtual camera corresponding to the first viewing angle when the virtual camera shoots the virtual scene, and the viewing angle range determines picture content of the first viewing angle picture that is displayed after the virtual camera shoots the virtual scene. In some embodiments, the viewing angle range is determined by a field of view (FOV) corresponding to the virtual camera, the FOV defines a width and a height of a visual field of the virtual camera, and a larger FOV indicates a wider virtual scene presented in the first viewing angle picture.

Before the character switching animation is displayed, the second virtual character that is in the virtual scene and that satisfies a character switching condition is determined based on the first viewing angle in response to receiving a character switching operation.

In some embodiments, manners of determining the second virtual character include the following two:

First, determining, when only one candidate virtual character exists within the viewing angle range corresponding to the first viewing angle, the candidate virtual character as the second virtual character.

Second, determining, when a plurality of candidate virtual characters exist within the viewing angle range corresponding to the first viewing angle, the second virtual character from the plurality of candidate virtual characters based on the character switching condition.

For example, when a plurality of candidate virtual characters exist within the viewing angle range corresponding to the first viewing angle, the second virtual character satisfying the character switching condition is selected from the plurality of candidate virtual characters.

In some embodiments, when a plurality of candidate virtual characters exist within the viewing angle range corresponding to the first viewing angle, the second virtual character is determined based on a distance between each candidate virtual character and the first virtual character.

Exemplarily, a candidate virtual character among the plurality of candidate virtual characters that has a distance to the first virtual character less than a first distance threshold is determined as the second virtual character. When there are a plurality of candidate virtual characters whose distances to the first virtual character are less than the first distance threshold, a candidate virtual character among the plurality of candidate virtual characters that has indicator data reaching a first data threshold is determined as the second virtual character.

In some embodiments, before the second virtual character is determined based on the indicator data, a data type of the indicator data and the corresponding first data threshold may be determined, and the data type and the first data threshold are determined based on a scene category of the virtual scene.

Exemplarily, the indicator data is data configured for indicating attributes of the candidate virtual characters in the virtual scene, for example, a health point, defense power, and an empirical value. In some embodiments, the data type of the indicator data is determined based on the scene category of the virtual scene. For example, when the scene category of the virtual scene belongs to a virtual combat scene, combat power (including attack power, defense power, and the like) of a virtual character is determined as the indicator data; when the scene category of the virtual scene belongs to a virtual survival scene, a health point of a virtual character is determined as the indicator data; when the scene category of the virtual scene belongs to a virtual driving scene, driving experience of a virtual character is determined as the indicator data.

Operation 230: Display the second viewing angle picture in response to that the presentation of the character switching process is completed.

The second viewing angle picture is a virtual scene picture corresponding to the second viewing angle of the second virtual character. For example, the second viewing angle picture is a picture in which a virtual scene is observed from the second viewing angle of the second virtual character.

In some embodiments, the second viewing angle may be a first-person view, a second-person view, a third-person view, or any other viewing angle corresponding to the second virtual character. In some embodiments, the third-person view is used as an example for description.

In some embodiments, the current main control virtual character is the second virtual character, and the viewing angle picture follows the second virtual character, for example, the viewing angle picture is the second viewing angle picture.

In some embodiments, the character state of the second virtual character is adjusted to the first state in response to that the display of the character switching animation is completed.

A character state of a candidate virtual character in the virtual scene is determined according to the main control virtual character. In some embodiments, the character state includes the first state and the second state. The first state is configured for indicating that the candidate virtual character is determined as the main control virtual character, and the second state is configured for indicating that the candidate virtual character does not currently belong to the main control virtual character.

In some embodiments, the character state of the second virtual character is determined as the first state in response to that the display of the character switching animation is completed, and the first state is configured for indicating that the second virtual character is controlled by a main control operation of the terminal. The character state of the first virtual character is determined as the second state, and the second state is configured for indicating that the first virtual character is static or the first virtual character is automatically controlled by a preset program.

To sum up, according to the method provided in some embodiments, in a process of switching a main control virtual character of a client, the client is triggered, by using a character switching operation, to present a character switching process to a user, and the first viewing angle picture before viewing angle switching and the second viewing angle picture after the viewing angle switching are connected through the character switching process. The character switching process includes an intermediate viewing angle presentation process, to present an intermediate viewing angle for transition from the first viewing angle of the current main control virtual character to the second viewing angle of a virtual character after the viewing angle switching, and the intermediate viewing angle is a transition viewing angle between the first viewing angle and the second viewing angle. For example, a transition process of switching from the first viewing angle picture to the second viewing angle picture is added by using an intermediate viewing angle picture. Therefore, when a display of a device displays a viewing angle switching process, the display no longer needs to directly switch from the first viewing angle picture to the second viewing angle picture within a short time, and a pixel unit of the display no longer needs to respond to rapid color changes between different viewing angle pictures within a short time, so that hardware pressure of the display and a device video card on picture response is reduced. In addition, the intermediate viewing angle picture enables a more fluent viewing angle switching process that accompanies character switching, so that visual continuity of the viewing angle switching process may be ensured.

According to the method provided in some embodiments, the character state of the virtual character is adjusted in response to that the display of the character switching animation is completed, the second virtual character is adjusted to the first state, and the first virtual character is adjusted to the second state, thereby implementing actual switching for the main control virtual character in the background. In addition, the first virtual character is adjusted to the second state, which may be automatically controlled by the preset program, so that the player may switch to and control a plurality of virtual characters during a game process, thereby increasing flexibility in controlling a plurality of virtual characters in a virtual scene. When a virtual character in the virtual scene is in the second state, for example, not mainly controlled by the user, the preset program takes over control of the virtual character, so as to ensure fluency of game play, avoid an error in a game process, avoid an error in an application program, and improve stability of a game program.

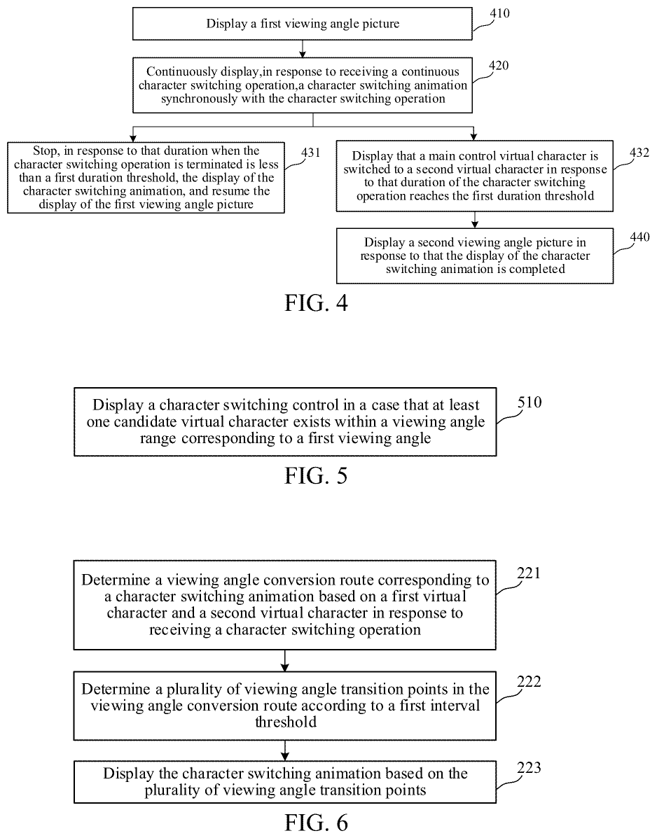

In some embodiments, operation 220 is implemented as: displaying the character switching animation based on duration of the character switching operation in response to receiving the character switching operation. When the character switching animation is synchronously displayed based on the duration of the character switching operation, the terminal determines the current main control virtual character according to the duration of the character switching operation. Exemplarily, FIG. 4 is a flowchart of a method for displaying a character switching animation according to some embodiments. The method may be performed by a terminal, or by a server, or by a terminal and a server in cooperation. In some embodiments, an example in which the method is performed by a terminal is used for description. As shown in FIG. 4, the method includes the following operations:

Operation 410: Display a first viewing angle picture.

The first viewing angle picture corresponds to a first viewing angle of a first virtual character. For example, the first viewing angle picture is a picture in which a virtual scene is observed from the first viewing angle of the first virtual character, and the first virtual character is a main control virtual character.

In some embodiments, operation 410 is implemented as operation 210.

Operation 420: Continuously display, in response to receiving a continuous character switching operation, the character switching animation synchronously with the character switching operation.

In some embodiments, after the duration of the character switching operation reaches the first duration threshold, if the current viewing angle does not transition to the second viewing angle and the user stops the character switching operation, the character switching animation continues to be automatically displayed, until the display of the character switching animation is completed.

In some embodiments, in a case that the duration when the character switching operation is terminated is less than the first duration threshold, character switching fails, and a lens position may be resumed to a position corresponding to the first viewing angle and move again with movement of the first viewing angle of the first virtual character.

The first duration threshold is configured for indicating duration for which the character switching operation may be continued for switching the main control virtual character from the first virtual character to the second virtual character.

Operation 431: Stop, in response to that the duration when the character switching operation is terminated is less than the first duration threshold, the display of the character switching animation, and resume the display of the first viewing angle picture.

Exemplarily, the client controls the main control virtual character to remain as the first virtual character.

The first duration threshold is configured for indicating duration for which the character switching operation may be continued for switching the main control virtual character from the first virtual character to the second virtual character.

In some embodiments, the terminal stops displaying the character switching animation, resumes displaying the first viewing angle picture, and ends this character switching process in response to that the duration when the character switching operation is terminated is less than the first duration threshold, and character switching fails.

In some embodiments, when the terminal stops displaying the character switching animation, the display of the first viewing angle picture may be resumed by directly resetting the lens position to the position corresponding to the first viewing angle, or the display of the first viewing angle picture may be resumed by displaying a character resuming animation. The character resuming animation includes a picture corresponding to an intermediate viewing angle for transition from the current viewing angle back to the first viewing angle.

Operation 432: Display that the main control virtual character is switched to the second virtual character in response to that the duration of the character switching operation reaches the first duration threshold.

In some embodiments, when the duration of the character switching operation reaches the first duration threshold, character switching is successful, and the terminal displays that the main control virtual character is switched to the second virtual character by displaying a second character identifier corresponding to the second virtual character, the second character identifier being configured for indicating that the current main control virtual character is the second virtual character.

In some embodiments, the character switching operation may be a long press operation, a continuous clicking operation, a continuous shaking operation, or the like.

In some embodiments, the long press operation is used as an example for description. In a case that the duration when the character switching operation is terminated is less than the first duration threshold, the main control virtual character remains as the first virtual character, and character switching is considered as being failed. In a case that the duration of the character switching operation reaches the first duration threshold, the main control virtual character is switched to the second virtual character, and character switching is considered as being succeeded.

In some embodiments, an input of a user is detected by using a user input detection module. When the user triggers a character switching operation, the user input detection module continuously detects the character switching operation and triggers a character switching process. When the user input detection module detects that duration of the character switching operation is less than the first duration threshold, the character switching process is terminated, and a main control virtual character is kept as the first virtual character. When the user input detection module detects that the duration of the character switching operation reaches the first duration threshold, the main control virtual character is switched to the second virtual character by using the character switching module. For example, the first virtual character is adjusted to the second state, and the second virtual character is adjusted to the first state by using the character switching module.

The second state is configured for indicating that the virtual character is not the current main control virtual character, and the first state is configured for indicating that the virtual character is the current main control virtual character.

Operation 440: Display the second viewing angle picture in response to that the display of the character switching animation is completed.

The second viewing angle picture is a virtual scene picture corresponding to the second viewing angle of the second virtual character. For example, the second viewing angle picture is a picture in which a virtual scene is observed from the second viewing angle of the second virtual character.

In some embodiments, operation 440 is implemented as operation 230.

To sum up, according to the method provided in some embodiments, the character switching animation is synchronously displayed based on the duration of the character switching operation, thereby increasing interactivity between the display of the character switching animation and a user operation in the character switching process.

According to the method provided in some embodiments, whether character switching is successful is determined according to whether duration of a character switching operation reaches the first duration threshold, and two manners of displaying a character switching animation are provided, to continuously display, in response to receiving a continuous character switching operation, the character switching animation synchronously with the character switching operation. When the duration of the character switching operation reaches the first duration threshold, switching from the main control virtual character to the second virtual character is displayed, to avoid a case in which character switching fails and the second viewing angle picture cannot be displayed because a user stops the character switching operation due to a misoperation. In response to that the duration when the character switching operation is terminated is less than the first duration threshold, the display of the character switching animation is stopped and the display of the first viewing angle picture is resumed, to avoid that the user triggers the character switching operation due to a misoperation and performs character switching without a character switching requirement, thereby reducing waste of computing resources. In addition, the user may give up or continue the character switching operation in real time according to an actual situation, which provides more fault-tolerant space for a misoperation of the user for character switching, improves flexibility of virtual character switching, and improves efficiency of human-computer interaction.

In some embodiments, the character switching operation is received by a character switching control, and a displaying process of the character switching control is further included before operation 220. FIG. 5 is a flowchart of a method for displaying a character switching control according to some embodiments. The method may be performed by a terminal, or by a server, or by a terminal and a server in cooperation. In some embodiments, an example in which the method is performed by a terminal is used for description. As shown in FIG. 5, the method includes the following operations before operation 220:

Operation 510: Display a character switching control in a case that at least one candidate virtual character exists within a viewing angle range corresponding to the first viewing angle.

The character switching control is configured for receiving the character switching operation.

In some embodiments, the character switching control may be fixedly displayed, or may be dynamically displayed according to a condition of the candidate virtual character. Being dynamically displayed is used as an example for description. When at least one candidate virtual character exists within the viewing angle range corresponding to the first viewing angle, the main control virtual character may be switched from the first virtual character to another candidate virtual character, and the character switching control is displayed, to explicitly remind the user that a character switching operation can be performed.

In some embodiments, the character switching control is correspondingly provided with a character identifier of the first virtual character, and the character identifier is configured for indicating that the current main control virtual character is the first virtual character.

In some embodiments, the viewing angle range corresponding to the first viewing angle is configured for indicating a candidate virtual character that is in the first viewing angle picture and has a distance to the first virtual character less than the first distance threshold.

Exemplarily, a distance between the first virtual character and another candidate virtual character is determined by using a Euclidean distance. Taking a two-dimensional space as an example, and assuming that location coordinates corresponding to the first virtual character are (x1, y1), and location coordinates corresponding to the second virtual character are (x2, y2), for a manner of determining the distance between the first virtual character and the second virtual character, refer to the following formula:

$$s = s q r t ( {( {x}_{1} - {x}_{2} )}^{2} + {( {y}_{1} - {y}_{2} )}^{2} )$$

where s is configured for indicating a distance between the first virtual character and the second virtual character. For example, coordinates x1 and x2 on the x-axis and coordinates y1 and y2 on the y-axis respectively corresponding to the first location coordinates (x1, y1) corresponding to the first virtual character and the second location coordinates (x2, y2) corresponding to the second virtual character are obtained. The first coordinate difference (x1-x2) on the x-axis and the second coordinate difference (y1-y2) on the y-axis are configured for determining the Euclidean distance between the first location of the first virtual character and the second location of the second virtual character based on the first coordinate difference and the second distance difference.

In some embodiments, when a distance between a virtual character in the first viewing angle picture and the first virtual character is less than the first distance threshold, the virtual character is determined as a candidate virtual character.

In some embodiments, the character switching control is displayed based on the duration of the character switching operation, the method further includes the following two operations after operation 510:

Operation I: Display first countdown based on a first character identifier in a case that the duration of the character switching operation is less than the first duration threshold.

The first countdown is configured for indicating remaining duration for which the character switching operation may be continued for switching the main control virtual character from the first virtual character to the second virtual character.

In a case that the duration of the character switching operation is less than the first duration threshold, the main control virtual character remains as the first virtual character.

A moment at which the character switching operation is triggered is recorded as the first moment, and a moment pushed backward from the first moment for a period of the first duration threshold is recorded as the second moment. The current moment is between the first moment and the second moment, and the first countdown is configured for indicating a time interval between the current moment and the second moment.

Exemplarily, when the client receives the operation trigger signal of the character switching operation and duration of the operation trigger signal is less than the first duration threshold, the client maintains the first character identifier (for example, a character identity (ID), a character avatar) displayed on the character switching control, and displays the first countdown associated with the first character identifier, and the first countdown indicates the remaining duration for which the current main control virtual character remains as the first virtual character.

Operation II: Display, based on the character switching control, a second character identifier corresponding to the second virtual character in a case that the duration of the character switching operation reaches the first duration threshold, and display second countdown based on the second character identifier.

The second countdown is configured for indicating the remaining duration for conversion of the current viewing angle picture into the second viewing angle picture.

The main control virtual character is switched to the second virtual character when the duration of the character switching operation reaches the first duration threshold.

Only a character switching control corresponding to the second character identifier is configured to receive the character switching operation of switching the main control virtual character from the second virtual character to another candidate virtual character, and the second character identifier is configured for indicating that the current main control virtual character is the second virtual character.

A moment at which the duration of the character switching operation reaches the first duration threshold is recorded as the first moment, and a moment at which the display of the character switching animation is completed is recorded as the second moment. The current moment is between the first moment and the second moment, and the first countdown is configured for indicating a time interval between the current moment and the second moment.

To sum up, according to the method provided in some embodiments, the character switching control is displayed when at least one candidate virtual character exists within the viewing angle range corresponding to the first viewing angle, to prompt, in a dynamic display manner, a user that a character switching operation may be performed in time and explicitly, and use an additional prompt element to implement a prompt function, thereby saving rendering resources, further avoiding a misoperation for character switching, and improving efficiency of human-computer interaction.

According to the method provided in some embodiments, when the duration of the character switching operation is less than the first duration threshold, the first countdown is displayed based on the first character identifier, to prompt the user of the remaining duration for which the character switching operation may be continued when the main control virtual character is switched from the first virtual character to the second virtual character, and to avoid a situation in which the user fails or cannot abandon switching in time because the user cannot accurately learn whether switching is succeeded, thereby further improving an error tolerance rate for a misoperation. In a case that the duration of the character switching operation reaches the first duration threshold, the second character identifier corresponding to the second virtual character is displayed, to visually prompt the user, by using identifier information displayed on the interface, that the current main control virtual character is switched to the second virtual character, thereby improving efficiency of human-computer interaction.

In some embodiments, the character switching animation is displayed by displaying an intermediate viewing angle picture, and the intermediate viewing angle picture in the character switching animation may be determined. FIG. 6 is a flowchart of a method for displaying a character switching animation according to some embodiments. The method may be performed by a terminal, or by a server, or by a terminal and a server in cooperation. In some embodiments, an example in which the method is performed by a terminal is used for description. As shown in FIG. 6, operation 220 includes the following operations:

Operation 221: Determine a viewing angle conversion route corresponding to the character switching animation based on the first virtual character and the second virtual character in response to receiving the character switching operation.

In some embodiments, the viewing angle conversion route is a connection line between a viewing angle point corresponding to the first viewing angle and a viewing angle point corresponding to the second viewing angle. In some embodiments, the connection line may be a straight line, or may be a curve.

Exemplarily, an example in which a viewing angle point is implemented as a center point of a virtual character is used. If the viewing angle conversion route is implemented as a straight line, a line segment between the first center point corresponding to the first virtual character and the second center point corresponding to the second virtual character is determined as the viewing angle conversion route. If the viewing angle conversion route is implemented as a curve, taking a semi-circular arc as an example, a midpoint of the line segment is used as a center of a sphere, half the length of the line segment is used as a radius, and any semi-circular arc from the first center point to the second center point in the sphere is determined as the viewing angle conversion route.

The manner of determining the viewing angle conversion route is merely an exemplary example. This is not limited in this application.

Operation 222: Determine a plurality of viewing angle transition points in the viewing angle conversion route according to the first interval threshold.

The viewing angle transition points are configured for indicating an intermediate viewing angle for transition from the first viewing angle to the second viewing angle.

In some embodiments, the plurality viewing angle transition points are location points of the intermediate viewing angle in the viewing angle conversion route in the process of transition from the first viewing angle to the second viewing angle.

In some embodiments, when the transition from the first viewing angle to the second viewing angle includes translation, the viewing angle transition points include location points through which the intermediate viewing angle is translated in the viewing angle conversion route. In some embodiments, when the transition from the first viewing angle to the second viewing angle includes rotation, the viewing angle transition points include location points at which the intermediate viewing angle is rotated in the viewing angle conversion route, and location points through which the intermediate viewing angle is translated in the viewing angle conversion route.

In some embodiments, when the transition from the first viewing angle to the second viewing angle includes both translation and rotation, the virtual camera preferentially performs rotation, or the virtual camera preferentially performs translation. This is not limited herein.

In some embodiments, manners of determining the viewing angle transition points include at least the following two:

First, uniformly determining the plurality of viewing angle transition points in the viewing angle conversion route according to a fixed first interval threshold.

Distances between the plurality of viewing angle transition points are the same.

Second, separately determining a plurality of first viewing angle transition points in the viewing angle conversion route according to a decreasing first interval threshold when the duration of the character switching operation is less than the first duration threshold; and separately determining a plurality of second viewing angle transition points in the viewing angle conversion route according to an ascending first interval threshold when the duration of the character switching operation reaches the first duration threshold.

The first viewing angle transition points are configured for indicating an intermediate viewing angle for transition from the first viewing angle to the second viewing angle in a case that the main control virtual character remains as the first virtual character; and the second viewing angle transition points are configured for indicating an intermediate viewing angle for transition from the first viewing angle to the second viewing angle in a case that the main control virtual character is switched to the second virtual character.

In some embodiments, a quantity of the viewing angle transition points is determined according to a frame rate of the terminal.

Exemplarily, in some embodiments, the viewing angle transition points are determined by interpolation. The viewing angle transition points are implemented as lens positions corresponding to the intermediate viewing angle. Assuming that the first viewing angle corresponds to a lens position A, and the second viewing angle corresponds to a lens position B, the viewing angle transition points corresponding to each frame are determined by linear interpolation. Taking a frame rate of the terminal of 60 frames/second as an example, for a manner of determining a viewing angle transition point corresponding to an nth frame, refer to the following formula:

$$C = A + ( B - A ) \times \frac{n}{60}$$

where C is a lens position indicated by the viewing angle transition point of the nth frame, n is a positive integer, for example, a distance between the first lens position (the lens position A) corresponding to the first viewing angle and the second lens position (the lens position B) corresponding to the second viewing angle is divided according to the frame rate, and the distance obtained through the division is added to the first lens position to obtain a lens position indicated by the viewing angle transition point of the nth frame.

Operation 223: Display the character switching animation based on the plurality of viewing angle transition points.

The character switching animation includes intermediate viewing angle pictures under the intermediate viewing angle corresponding to the plurality of viewing angle transition points.

Exemplarily, as shown in FIG. 3, a terminal displays the first viewing angle picture 310, and displays a character switching animation in response to receiving a character switching operation. The character switching animation includes an intermediate viewing angle picture 321 and an intermediate viewing angle picture 322, and displays the second viewing angle picture 330 in response to that the display of the character switching animation is completed.

To sum up, according to the method provided in some embodiments, a viewing angle conversion route is determined, a plurality of viewing angle transition points are determined in the viewing angle conversion route according to the first interval threshold, and a character switching animation is displayed based on the plurality of viewing angle transition points, so that a manner of displaying the character switching animation is determined. An intermediate viewing angle picture is determined by using the viewing angle transition points in the viewing angle conversion route as an intermediate viewing angle, so that a transition picture in a virtual character switching process is added, and the character switching animation is smoother and more fluent.

According to the method provided in some embodiments, a plurality of different solutions for determining the viewing angle transition points are provided. A plurality of viewing angle transition points are uniformly determined in the viewing angle conversion route according to a fixed first interval threshold, so that distances between the viewing angle transition points are the same. For example, a lens position is moved at a uniform speed in a displaying process of a viewing angle switching animation, so that a picture change process is smooth and fluent. A plurality of second viewing angle transition points are separately determined in the viewing angle conversion route according to a decreasing first interval threshold when the duration of the character switching operation is less than the first duration threshold. A plurality of second viewing angle transition points are separately determined in the viewing angle conversion route according to an ascending first interval threshold when the duration of the character switching operation reaches the first duration threshold. The viewing angle transition points are determined according to different first interval thresholds, so that the user can perceive a character switching situation according to a change of a lens position moving speed, thereby improving interactivity.

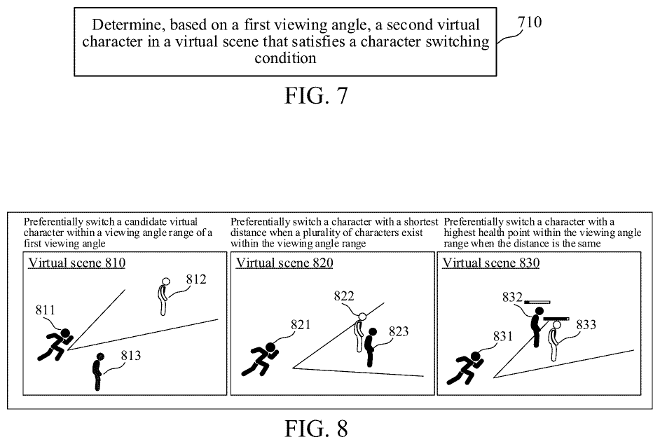

In some embodiments, the second virtual character further may be determined before operation 220. In some embodiments, the second virtual character may be autonomously selected by the user, or may be automatically determined by the terminal. In some embodiments, an example in which the second virtual character is automatically determined by the terminal is used for description. FIG. 7 is a flowchart of a method for determining a second virtual character according to some embodiments. The method may be performed by a terminal, or by a server, or by a terminal and a server in cooperation. In some embodiments, an example in which the method is performed by a terminal is configured for description. As shown in FIG. 7, the method further includes the following operations before operation 220:

Operation 710: Determine, based on the first viewing angle, the second virtual character in the virtual scene that satisfies a character switching condition.

In some embodiments, the character switching condition includes at least one of: the second virtual character is located within the viewing angle range corresponding to the first viewing angle, indicator data of the second virtual character reaches the first data threshold, or the second virtual character is a virtual character selected based on a character selection operation.

In some embodiments, operation 710 includes the following two operations:

First, determining, when only one candidate virtual character exists within the viewing angle range corresponding to the first viewing angle, the candidate virtual character as the second virtual character.

In some embodiments, the candidate virtual character refers to a virtual character with a character state controllable in the virtual scene.

The character state of the virtual character includes a controllable state and an uncontrollable state. The controllable state is configured for indicating that the virtual character belongs to a candidate virtual character, and the candidate virtual character may be determined as a main control virtual character. The uncontrollable state is configured for indicating that the virtual character does not belong to a candidate virtual character, for example, a virtual character mainly controlled by the server or another terminal.

The controllable state and the uncontrollable state of the virtual character in the virtual scene may be pre-configured by the target application program, or may be configured by the user.

In some embodiments, the controllable state and the uncontrollable state of the virtual character in the virtual scene are determined based on a camp to which the virtual character belongs. For example, a virtual character in a camp in which the first account is located is in the controllable state, and a virtual character in another camp is in the uncontrollable state.

Second, determining, when a plurality of candidate virtual characters exist within the viewing angle range corresponding to the first viewing angle, the second virtual character from the plurality of candidate virtual characters based on the character switching condition.

In some embodiments, determining the second virtual character from the plurality of candidate virtual characters includes the following two operations:

Operation I: Determine a candidate virtual character among the plurality of candidate virtual characters that has a distance to the first virtual character less than the first distance threshold as the second virtual character.

In some embodiments, distances between the plurality of candidate virtual characters and the first virtual character are determined separately, and the candidate virtual character having the smallest distance is determined as the second virtual character.

Operation II: When there are a plurality of candidate virtual characters whose distances to the first virtual character are less than the first distance threshold, determining a candidate virtual character among the plurality of candidate virtual characters that has indicator data reaching the first data threshold as the second virtual character, the indicator data being data for indicating an attribute of the candidate virtual character in the virtual scene.

In some embodiments, a virtual character corresponds to a plurality of pieces of candidate indicator data. Before the second virtual character is determined based on the indicator data, a data type of the indicator data and the corresponding first data threshold may be determined, and the data type and the first data threshold are determined based on a scene category of the virtual scene. For example, before operation II, the scene category of the virtual scene is determined, the scene category being used to indicate the data type of the indicator data, and the indicator data is determined based on the scene category in the plurality of pieces of candidate indicator data corresponding to the virtual character. The first data threshold corresponding to the indicator data is determined.

Exemplarily, when the scene category of the virtual scene belongs to a virtual combat scene, combat power (including attack power, defense power, and the like) of a virtual character is determined as the indicator data; when the scene category of the virtual scene belongs to a virtual survival scene, a health point of a virtual character is determined as the indicator data; when the scene category of the virtual scene belongs to a virtual driving scene, driving experience of a virtual character is determined as the indicator data.

FIG. 8 is a schematic diagram of a method for determining a second virtual character according to some embodiments. As shown in FIG. 8, an example in which the indicator data is implemented as a health point is used for description. A virtual scene 810 includes a first virtual character 811, a candidate virtual character 812, and a candidate virtual character 813, and only the candidate virtual character 812 is located within a viewing angle range corresponding to the first viewing angle of the first virtual character 811, so the candidate virtual character 812 is determined as the second virtual character. A virtual scene 820 includes a first virtual character 821, a candidate virtual character 822, and a candidate virtual character 823, and the candidate virtual character 822 and the candidate virtual character 823 are both located within a viewing angle range corresponding to the first viewing angle of the first virtual character 821, so the candidate virtual character 822 closer to the first virtual character 821 is determined as the second virtual character. A virtual scene 830 includes a first virtual character 831, a candidate virtual character 832, and a candidate virtual character 833, the candidate virtual character 832 and the candidate virtual character 833 are both located within a viewing angle range corresponding to the first viewing angle of the first virtual character 831, and the candidate virtual character 832 and the candidate virtual character 833 have the same distance to the first virtual character 831, so the candidate virtual character 833 having a higher health point is determined as the second virtual character.

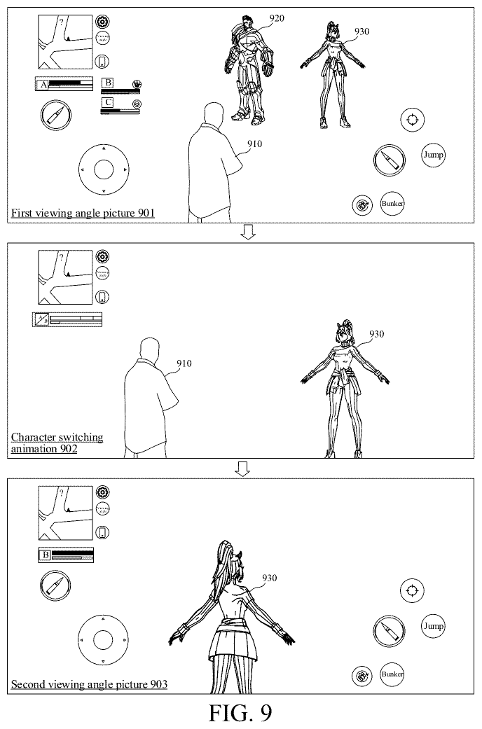

Exemplarily, FIG. 9 is a schematic diagram of virtual character switching according to some embodiments. As shown in FIG. 9, a first viewing angle picture 901 corresponding to a first virtual character 910 is displayed. A virtual scene includes the first virtual character 910, a candidate virtual character 920, and a candidate virtual character 930; both the candidate virtual character 920 and the candidate virtual character 930 are located within a viewing angle range of the first viewing angle corresponding to the first virtual character 910; and the candidate virtual character 920 and the candidate virtual character 930 have the same distance to the first virtual character 910. Base on that the current virtual scene is implemented as a virtual combat scene, combat power is used as indicator data, the candidate virtual character 930 having the combat power reaching the first data threshold is determined as the second virtual character, a character switching animation 902 is displayed in response to receiving a character switching operation, and a second viewing angle picture 903 corresponding to the second virtual character (the candidate virtual character 930) is displayed in response to that the display of the character switching animation 902 is completed.

To sum up, according to the method provided in some embodiments, before the character switching animation is displayed, the second virtual character that is in the virtual scene and that satisfies a character switching condition is determined based on the first viewing angle, so that a solution in which the terminal automatically determines the second virtual character is provided, thereby reducing a process in which the user manually selects the second virtual character, improving automation of virtual character switching, and improving efficiency of virtual character switching.

According to the method provided in some embodiments, the second virtual character is preferentially determined according to the candidate virtual character within the viewing angle range corresponding to the first viewing angle, so that a process of implementing virtual character switching better conforms to an actual switching situation and has a more vicarious feeling.

According to the method provided in some embodiments, when a plurality of candidate virtual characters exist within the viewing angle range corresponding to the first viewing angle, the second virtual character is preferentially determined according to a distance between the candidate virtual character and the first virtual character, so that a candidate virtual character with a shorter viewing angle conversion path is preferentially selected in a process of automatically determining the second virtual character, thereby reducing computing and rendering resources consumed by the character switching animation, and improving appropriateness of the second virtual character. When there are a plurality of candidate virtual characters whose distances to the first virtual character are less than the first distance threshold, a candidate virtual character among the plurality of candidate virtual characters that has indicator data reaching the first data threshold is determined as the second virtual character, so that the manners of determining the second virtual character are further clarified, and automation of a process of determining the second virtual character is improved.

According to the method provided in some embodiments, the scene category of the virtual scene is determined, and the indicator data is determined based on the scene category in the plurality of pieces of candidate indicator data corresponding to the virtual character. The first data threshold corresponding to the indicator data is determined, so that the second virtual character determined based on the indicator data better conforms to an actual requirement of the user, thereby improving determining quality of the second virtual character.

In some embodiments, the virtual character switching method provided in some embodiments may be performed by a terminal, or by a server, or by a terminal and a server in cooperation. In some embodiments, an example in which the method is performed by a terminal is used for description. The terminal performs the virtual character switching method by jointly using a user input detection module, a character screening module, a viewing angle conversion module, a character switching module, a user interaction module, and a character switching completion module. The user input detection module is configured to detect a user input, and trigger a character switching process when a user triggers a character switching operation; the character screening module is configured to determine the second virtual character; the viewing angle conversion module is configured to display a viewing angle switching animation; the character switching module is configured to switch a main control virtual character; the user interaction module is configured to continuously detect a user input during the character switching process, and determine duration of the character switching operation; and the character switching completion module is configured to determine the main control virtual character after character switching is completed.

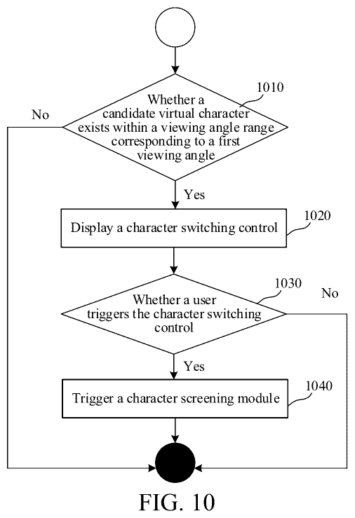

Exemplarily, FIG. 10 is a flowchart of a method for determining a user-switchable character according to some embodiments. As shown in FIG. 10, the terminal sequentially performs operation 1010: determine whether a candidate virtual character exists within a viewing angle range corresponding to the first viewing angle, and perform operation 1020 in response to that a candidate virtual character exists; operation 1020: display a character switching control; operation 1030: determine whether the user triggers the character switching control, and perform operation 1040 in response to that the user triggers the character switching control; and operation 1040: trigger the character screening module, for example, determine the second virtual character.

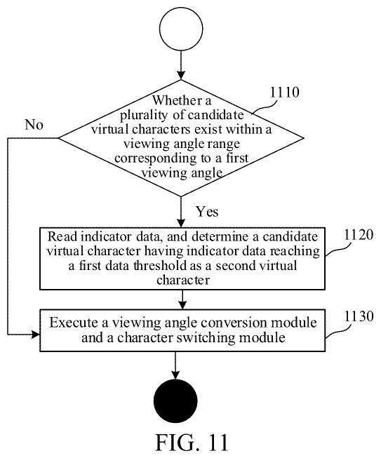

Exemplarily, FIG. 11 is a flowchart of a character screening module according to some embodiments. As shown in FIG. 11, the terminal sequentially performs operation 1110: determine whether a plurality of candidate virtual characters exist within a viewing angle range corresponding to the first viewing angle, and perform operation 1120 in response to that a plurality of candidate virtual characters exist, or otherwise, directly determine the candidate virtual character within the viewing angle range corresponding to the first viewing angle as the second virtual character and perform operation 1130; operation 1120: read indicator data, and determine a candidate virtual character having indicator data reaching the first data threshold as the second virtual character; and operation 1130: execute the viewing angle conversion module and the character switching module.

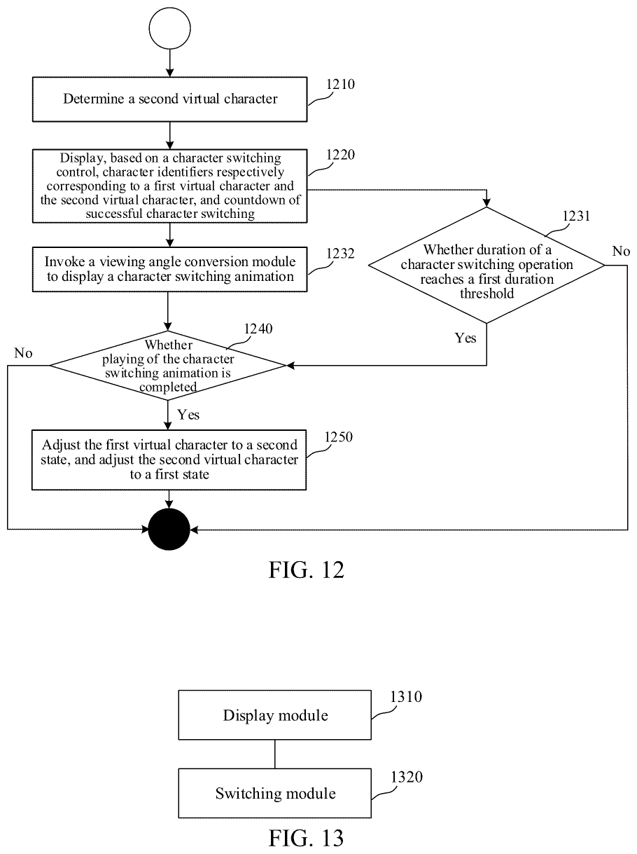

Exemplarily, FIG. 12 is a flowchart of character switching according to some embodiments. As shown in FIG. 12, the terminal sequentially performs operation 1210: determine the second virtual character; operation 1220: display, based on the character switching control, character identifiers respectively corresponding to the first virtual character and the second virtual character, and countdowns of successful character switching; operation 1231: determine whether duration of the character switching operation reaches the first duration threshold, and perform operation 1240 if the duration of the character switching operation reaches the first duration threshold; operation 1232 (in parallel with operation 1231): invoke the viewing angle conversion module to display a character switching animation; operation 1240: determine whether playing of the character switching animation is completed, and perform operation 1250 in response to that the playing of the character switching animation is completed; and operation 1250: adjust the first virtual character to the second state, and adjust the second virtual character to the first state. A preset program is enabled for the virtual character in the second state to automatically control the virtual character.

Based on the virtual character switching method provided in some embodiments, a smooth and natural character switching effect can be achieved, and interactivity and immersive feeling in a virtual character switching process can be improved. When a user performs a character switching operation, a game automatically selects a candidate virtual character that is within a viewing angle range of the first viewing angle, is closest, and/or has a highest health point for switching, and a viewing angle smoothly switch from the first virtual character to the second virtual character, so that the user can better control and experience a multi-character game. In addition, more fault-tolerant space is provided for a user misoperation. Before the duration of the character switching operation reaches the first duration threshold, if the user stops clicking in the viewing angle switching process, the character switching process is immediately stopped, and the current character and viewing angle are maintained, thereby providing a more flexible operation manner.

FIG. 13 is a structural block diagram of a virtual character switching apparatus according to some embodiments. As shown in FIG. 13, the apparatus includes the following parts:
a display module 1310, configured to display a first viewing angle picture, the first viewing angle picture being a picture in which a virtual scene is observed from a first viewing angle of a first virtual character, and the first virtual character being a main control virtual character; and
a switching module 1320, configured to present a character switching process from the first virtual character to a second virtual character in response to receiving a character switching operation, the character switching operation being configured for switching the main control virtual character from the first virtual character to the second virtual character, the character switching process including an intermediate viewing angle presentation process, and the intermediate viewing angle presentation process being a process corresponding to an intermediate viewing angle for transition from the first viewing angle to a second viewing angle,
the display module 1310 being further configured to display a second viewing angle picture in response to that the presentation of the character switching process is completed, and the second viewing angle picture being a picture in which the virtual scene is observed from a second viewing angle of the second virtual character.

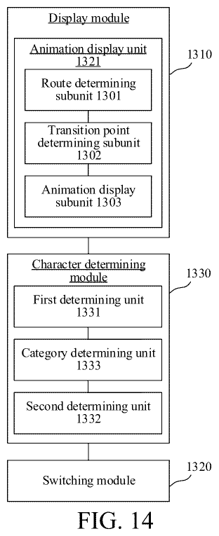

FIG. 14 is a structural block diagram of a virtual character switching apparatus module according to some embodiments. As shown in FIG. 14, in some embodiments, the switching module 1320 includes:
an animation display unit 1321, configured to synchronously display, in response to receiving the character switching operation, the character switching animation based on duration of the character switching operation.

In some embodiments, the animation display unit 1321 is configured to:
continuously display, in response to receiving a continuous character switching operation, the character switching animation synchronously with the character switching operation; and
display that the main control virtual character is switched to the second virtual character in response to that the duration of the character switching operation reaches the first duration threshold; or, stop, in response to that the duration when the character switching operation is terminated is less than the first duration threshold, the display of the character switching animation, resume the display of the first viewing angle picture, and control the main control virtual character to remain as the first virtual character.

In some embodiments, the display module 1310 is further configured to display a character switching control in a case that at least one candidate virtual character exists within a viewing angle range corresponding to the first viewing angle, the character switching control being configured for receiving the character switching operation.

In some embodiments, the character switching control is correspondingly provided with the first character identifier of the first virtual character; the display module 1310 is further configured to:
display the first countdown based on the first character identifier in a case that the duration of the character switching operation is less than the first duration threshold, the first countdown being configured for indicating remaining duration for which the character switching operation may be continued when the main control virtual character is switched from the first virtual character to the second virtual character; and
display, based on the character switching control in a case that the duration of the character switching operation reaches the first duration threshold, the second character identifier corresponding to the second virtual character, and display the second countdown based on the second character identifier, the second countdown being configured for indicating remaining duration for conversion of the current viewing angle picture into the second viewing angle picture.

In some embodiments, the animation display unit 1321 includes:
a route determining subunit 1301, configured to determine a viewing angle conversion route corresponding to the character switching animation based on a position relationship between the first virtual character and the second virtual character in response to receiving the character switching operation;
a transition point determining subunit 1302, configured to determine a plurality of viewing angle transition points in the viewing angle conversion route according to the first interval threshold, the viewing angle transition points being configured for indicating the intermediate viewing angle for transition from the first viewing angle to the second viewing angle; and
an animation display subunit 1303, configured to display the character switching animation based on the plurality of viewing angle transition points, the character switching animation including an intermediate viewing angle picture under the intermediate viewing angle corresponding to the plurality of viewing angle transition points.

In some embodiments, the transition point determining subunit 1302 is configured to:
uniformly determine the plurality of viewing angle transition points in the viewing angle conversion route according to a fixed first interval threshold, distances between the plurality of viewing angle transition points being the same; or,
separately determine a plurality of first viewing angle transition points in the viewing angle conversion route according to a decreasing first interval threshold when the duration of the character switching operation is less than the first duration threshold, the first viewing angle transition points being configured for indicating an intermediate viewing angle for transition from the first viewing angle to the second viewing angle in a case that the main control virtual character remains as the first virtual character; and separately determine a plurality of second viewing angle transition points in the viewing angle conversion route according to an ascending first interval threshold when the duration of the character switching operation reaches the first duration threshold, the second viewing angle transition points being configured for indicating an intermediate viewing angle for transition from the first viewing angle to the second viewing angle in a case that the main control virtual character is switched to the second virtual character.

In some embodiments, the apparatus further includes a character determining module 1330 which is configured to determine, based on the first viewing angle, the second virtual character that is in the virtual scene and that satisfies a character switching condition.

In some embodiments, the character determining module 1330 includes:
the first determining unit 1331, configured to determine, when only one candidate virtual character exists within the viewing angle range corresponding to the first viewing angle, the candidate virtual character as the second virtual character; and
the second determining unit 1332, configured to determine, when a plurality of candidate virtual characters exist within the viewing angle range corresponding to the first viewing angle, the second virtual character from the plurality of candidate virtual characters based on the character switching condition.

In some embodiments, the second determining unit 1332 is configured to:
determine a candidate virtual character among the plurality of candidate virtual characters that has a distance to the first virtual character less than the first distance threshold as the second virtual character; and
when there are a plurality of candidate virtual characters whose distances to the first virtual character are less than the first distance threshold, determine a candidate virtual character among the plurality of candidate virtual characters that has indicator data reaching the first data threshold as the second virtual character, the indicator data being data for indicating an attribute of the candidate virtual character in the virtual scene.

In some embodiments, the character determining module 1330 further includes a category determining unit 1333 which is configured to:
determine a scene category of the virtual scene, the scene category being configured for indicating a data type of the indicator data; and
determine, based on the scene category, the indicator data from a plurality of pieces of candidate indicator data corresponding to the virtual character; and determine the first data threshold corresponding to the indicator data.

In some embodiments, the switching module 1320 is configured to:
determine the character state of the second virtual character as the first state in response to that the display of the viewing angle switching animation is completed, the first state being configured for indicating that the second virtual character is controlled by a main control operation of a terminal; and
determine the character state of the first virtual character as the second state, the second state being configured for indicating that the first virtual character is static or the first virtual character is automatically controlled by a preset program.

The virtual character switching apparatus provided in the foregoing embodiment is illustrated only with an example of division of the foregoing function modules. In practical applications, the foregoing functions may be allocated to and completed by different function modules based on requirements. For example, an internal structure of the apparatus is divided into different function modules to complete all or some of the functions described above.

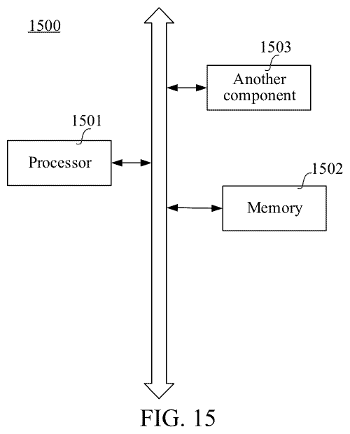

FIG. 15 is a structural block diagram of a terminal 1500 according to some embodiments. The terminal 1500 may be: a smartphone, a tablet computer, an MP3 player, an MP4 player, a notebook computer, or a desktop computer. The terminal 1500 may alternatively be referred to as another name such as a user device, a portable terminal, a laptop terminal, or a desktop terminal.

Generally, the terminal 1500 includes a processor 1501 and a memory 1502.

The processor 1501 may include one or more processing cores, for example, a 4-core processor or an 8-core processor. The processor 1501 may be implemented by using at least one hardware form of a digital signal processing (DSP), a field-programmable gate array (FPGA), and a programmable logic array (PLA). The processor 1501 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1501 may be integrated with a graphics processing unit (GPU). The GPU is configured to render and draw content that may be displayed on a display screen. In some embodiments, the processor 1501 may further include an artificial intelligence (AI) processor. The AI processor is configured to process computing operations correlated with machine learning.

The memory 1502 may include one or more computer-readable storage media. The computer-readable storage media may be non-transient. In some embodiments, the non-transitory computer-readable storage medium in the memory 1502 is configured to store at least one instruction. The at least one instruction is configured to being executed by the processor 1501 to implement the virtual character switching method provided in the method embodiments of this application.

In some embodiments, the terminal 1500 further include another component 1503. A person skilled in the art may understand that the structure shown in FIG. 15 constitutes no limitation on the terminal 1500, and the terminal 1500 may include more or fewer components than those shown in the figure, or a combination of some components, or have a different arrangement of components.

In some embodiments, a computer device is further provided. The computer device may be implemented as the terminal or the server shown in FIG. 1. The computer device includes a processor and a memory, the memory having at least one instruction, at least one program, a code set, or an instruction set stored therein, the at least one instruction, the at least one program, the code set, or the instruction set being loaded and executed by the processor to implement the virtual character switching method according to the foregoing method embodiments.

In some embodiments, a computer-readable storage medium is further provided, having at least one instruction, at least one program, a code set, or an instruction set stored therein, the at least one instruction, the at least one program, the code set, or the instruction set being loaded and executed by a processor to implement the virtual character switching method according to the foregoing method embodiments.

In some embodiments, a computer program product or a computer program is further provided, including computer instructions, the computer instructions being stored in the computer-readable storage medium. A processor of a computer device reads the computer instructions from the computer-readable storage medium and executes the computer instructions, to cause the computer device to perform the virtual character switching method according to the foregoing method embodiments.

An ordinary person skilled in the art may understand that all or some of the operations of the foregoing embodiments may be implemented by hardware, or may be implemented by a program instructing relevant hardware. The program may be stored in the computer-readable storage medium. The above-mentioned storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A virtual character switching method, performed by a computer device, the method comprising:
displaying a first viewing angle picture of a virtual scene, wherein the first viewing angle picture corresponds to a first viewing angle of a first virtual character that is a main control virtual character;
based on receiving a character switching operation for switching the main control virtual character from the first virtual character to a second virtual character, presenting a character switching process that includes an intermediate viewing angle presentation process corresponding to an intermediate viewing angle for transition from the first viewing angle to a second viewing angle; and
displaying a second viewing angle picture of the virtual scene corresponding to the second viewing angle of the second virtual character after completion of the character switching process.

2. The virtual character switching method according to claim 1, wherein the presenting a character switching process comprises:
displaying a character switching animation that includes an intermediate viewing angle picture corresponding to the intermediate viewing angle.

3. The virtual character switching method according to claim 2, wherein the displaying the character switching animation comprises:
synchronously displaying the character switching animation based on duration of the character switching operation.

4. The virtual character switching method according to claim 3, wherein the synchronously displaying the character switching animation comprises:
continuously displaying, based on receiving a continuous character switching operation, the character switching animation synchronously with the character switching operation; and
switching the main control virtual character to the second virtual character based on the duration reaching a first duration threshold; or
stopping display of the character switching animation and resuming display of the first viewing angle picture based on the character switching operation being terminated before reaching the first duration threshold.

5. The virtual character switching method according to claim 1, further comprising:
displaying a character switching control based on at least one candidate virtual character existing within a viewing angle range corresponding to the first viewing angle, wherein the character switching control is configured to receive the character switching operation.

6. The virtual character switching method according to claim 5, wherein the character switching control comprises a first character identifier of the first virtual character; and the method further comprises:
displaying a first countdown based on the first character identifier based on the duration of the character switching operation being less than the first duration threshold,
wherein the first countdown is configured to indicate remaining duration for the character switching operation to switch the main control virtual character from the first virtual character to the second virtual character;
displaying, based on the duration of the character switching operation reaching the first duration threshold, a second character identifier corresponding to the second virtual character; and
displaying second countdown based on the second character identifier, the second countdown being configured to indicate remaining duration for converting a current viewing angle picture into the second viewing angle picture.

7. The virtual character switching method according to claim 2, wherein the displaying the character switching animation comprises:
determining a viewing angle conversion route based on a position relationship between the first virtual character and the second virtual character, based on receiving the character switching operation;
determining a plurality of viewing angle transition points in the viewing angle conversion route based on a first interval threshold, the viewing angle transition points being configured to indicate the intermediate viewing angle for transition from the first viewing angle to the second viewing angle; and
displaying the character switching animation based on the plurality of viewing angle transition points, wherein the character switching animation comprises an intermediate viewing angle picture under the intermediate viewing angle corresponding to the plurality of viewing angle transition points.

8. The virtual character switching method according to claim 7, wherein the determining a plurality of viewing angle transition points in the viewing angle conversion route according to a first interval threshold comprises at least one of:
uniformly determining the plurality of viewing angle transition points in the viewing angle conversion route based on a fixed first interval threshold that distances between the plurality of viewing angle transition points are the same; or,
determining a first set of viewing angle transition points along the viewing angle conversion route according to a decreasing first interval threshold when duration of the character switching operation is less than a first duration threshold, wherein the main control virtual character remains as the first virtual character, and determining a second set of viewing angle transition points along the viewing angle conversion route according to an increasing first interval threshold when the duration of the character switching operation reaches the first duration threshold, wherein the main control virtual character is switched to the second virtual character.

9. The virtual character switching method according to claim 1, further comprising:
determining, based on the first viewing angle, the second virtual character in the virtual scene that satisfies a character switching condition.

10. The virtual character switching method according to claim 9, wherein the determining the second virtual character comprises:
determining, based on only one candidate virtual character existing within the viewing angle range corresponding to the first viewing angle, the candidate virtual character as the second virtual character; or
selecting, based on a plurality of candidate virtual characters existing within the viewing angle range corresponding to the first viewing angle, the second virtual character from the plurality of candidate virtual characters based on the character switching condition.

11. A virtual character switching apparatus, comprising:
at least one memory configured to store program code; and
at least one processor configured to read the program code and operate as instructed by the program code, the program code comprising:
first display code configured to cause at least one of the at least one processor to display a first viewing angle picture of a virtual scene, wherein the first viewing angle picture corresponds to a first viewing angle of a first virtual character that is a main control virtual character;
switching code configured to cause at least one of the at least one processor to present, based on receiving a character switching operation for switching the main control virtual character from the first virtual character to a second virtual character, a character switching process that includes an intermediate viewing angle presentation process corresponding to an intermediate viewing angle for transition from the first viewing angle to a second viewing angle; and
second display code configured to cause at least one of the at least one processor to display a second viewing angle picture of the virtual scene corresponding to the second viewing angle of the second virtual character after completion of the character switching process.

12. The virtual character switching apparatus according to claim 11, wherein the switching code is further configured to cause at least one of the at least one processor to:
display a character switching animation that includes an intermediate viewing angle picture corresponding to the intermediate viewing angle.

13. The virtual character switching apparatus according to claim 12, wherein the switching code is further configured to cause at least one of the at least one processor to:
synchronously display the character switching animation based on duration of the character switching operation.

14. The virtual character switching apparatus according to claim 13, wherein the switching code is further configured to cause at least one of the at least one processor to:
continuously display, based on receiving a continuous character switching operation, the character switching animation synchronously with the character switching operation; and
switch the main control virtual character to the second virtual character based on the duration reaching a first duration threshold; or
stop display of the character switching animation and resume display of the first viewing angle picture based on the character switching operation being terminated before reaching the first duration threshold.

15. The virtual character switching apparatus according to claim 11, wherein the program code further comprises:
control code configured to cause at least one of the at least one processor to display a character switching control based on at least one candidate virtual character existing within a viewing angle range corresponding to the first viewing angle, wherein the character switching control is configured to receive the character switching operation.

16. The virtual character switching apparatus according to claim 15, wherein the character switching control comprises a first character identifier of the first virtual character; and wherein the control code is further configured to cause at least one of the at least one processor to:
display a first countdown based on the first character identifier based on the duration of the character switching operation being less than the first duration threshold,
wherein the first countdown is configured to indicate remaining duration for the character switching operation to switch the main control virtual character from the first virtual character to the second virtual character;
display, based on the duration of the character switching operation reaching the first duration threshold, a second character identifier corresponding to the second virtual character; and
display second countdown based on the second character identifier, the second countdown being configured to indicate remaining duration for converting a current viewing angle picture into the second viewing angle picture.

17. The virtual character switching apparatus according to claim 12, wherein the switching code is further configured to cause at least one of the at least one processor to:
determine a viewing angle conversion route based on a position relationship between the first virtual character and the second virtual character, based on receiving the character switching operation;
determine a plurality of viewing angle transition points in the viewing angle conversion route based on a first interval threshold, the viewing angle transition points being configured to indicate the intermediate viewing angle for transition from the first viewing angle to the second viewing angle; and
display the character switching animation based on the plurality of viewing angle transition points, wherein the character switching animation comprises an intermediate viewing angle picture under the intermediate viewing angle corresponding to the plurality of viewing angle transition points.

18. The virtual character switching apparatus according to claim 17, wherein the switching code is further configured to cause at least one of the at least one processor to perform at least one of:
uniformly determine the plurality of viewing angle transition points in the viewing angle conversion route based on a fixed first interval threshold that distances between the plurality of viewing angle transition points are the same; or,
determine a first set of viewing angle transition points along the viewing angle conversion route according to a decreasing first interval threshold when duration of the character switching operation is less than a first duration threshold, wherein the main control virtual character remains as the first virtual character; and
determine a second set of viewing angle transition points along the viewing angle conversion route according to an increasing first interval threshold when the duration of the character switching operation reaches the first duration threshold, wherein the main control virtual character is switched to the second virtual character.

19. The virtual character switching apparatus according to claim 11, wherein the program code further comprises:
character code configured to cause at least one of the at least one processor to determine, based on the first viewing angle, the second virtual character in the virtual scene that satisfies a character switching condition.

20. A non-transitory computer-readable storage medium, storing computer code which, when executed by at least one processor, causes the at least one processor to at least:
display a first viewing angle picture of a virtual scene, wherein the first viewing angle picture corresponds to a first viewing angle of a first virtual character that is a main control virtual character;
present, based on receiving a character switching operation for switching the main control virtual character from the first virtual character to a second virtual character, a character switching process that includes an intermediate viewing angle presentation process corresponding to an intermediate viewing angle for transition from the first viewing angle to a second viewing angle; and
display a second viewing angle picture of the virtual scene corresponding to the second viewing angle of the second virtual character after completion of the character switching process.
